(19) United States
(12) Patent Application Publication
(10) Pub. No.: US 2004/0032164 A1
(43) Pub. Date: Feb. 19, 2004

(54) Electronic control device

(75) Inventors: Takao Tsunooka, Kariya-shi (JP); Hiroyuki Masubuchi, Kariya-shi (JP); Matsuhisa Tsuruta, Toyota-shi (JP); Takeshi Ikeyama, Nagoya-shi (JP)

Correspondence Address: BURNS, DOANE, SWECKER & MATHIS, L.L.P., P.O. Box 1404, Alexandria, VA, 22313-1404, US

(73) Assignee: AISIN SEIKI KABUSHIKI KAISHA

(21) Appl. No.: 10/443,883

(22) Filed: May 23, 2003

(30) Foreign Application Priority Data
May 23, 2002 (JP) 2002-149503

(51) Int. Cl. B60T 8/36

(52) U.S. Cl. 303/119.3

(57) ABSTRACT

An electronic control device includes plural cylindrical coils and a set of a primary yoke and a secondary yoke. The primary yoke is provided at each one side of the plural coils and the secondary yoke is provided at each the other side of the plural coils in axial direction. A case member houses the plural coils, the primary yoke, and the secondary yoke. The primary yoke is connected to the secondary yoke and has lateral portions extending in the axial direction of the plural coils.

### CROSS REFERENCE TO RELATED APPLICATIONS

The application is based on and claims priority under 35 U.S.C. §119 with respect to a Japanese Patent Application 2002-149503, filed on May 23, 2002, the entire content of which is incorporated herein by reference.

### FIELD OF THE INVENTION

This invention generally relates to an electronic control device, and more particularly, this invention pertains to an electronic control device for operating and controlling a pressure control device such as an ABS actuator of a vehicle.

### BACKGROUND OF THE INVENTION

For example, a known electronic control device is disclosed in a Japanese Utility Model Application Laid-Open Publication No. 6(1994)-59679. The device is used to operate and control a pressure control device of a vehicle including a solenoid valve. This electronic control device has eight cylindrical coils, cylindrical yokes corresponding to each cylindrical coil, and a magnetic metallic plate. The respective cylindrical yokes surround the respective cylindrical coils. Solenoid valves corresponding to each cylindrical coil are magnetically connected to the respective cylindrical yokes by the common magnetic metallic plate.

However, in the known electronic control device, above described, the respective cylindrical coils have the cylindrical yokes corresponding to each cylindrical coil, so the number of parts to be assembled increases. Thus, parts cost also increases, and then assembly operation becomes more complex. Particularly, when electronic control device requires more solenoid valves for advanced pressure controlling on vehicle stability control, the foregoing problem is severe. On one hand, when two magnetic metallic plates are provided at both sides of the coils in axial direction and the two plates are magnetically connected each other via collars where fixing bolts are inserted, the two magnetic metallic plates can cover the plural coils as a common yoke. Though, in this case, portions where the collars are provided correspond to a magnetic passage and require waterproofing with high accuracy. Thus, packing provided between the electronic control device and the pressure control device needs to be enlarged so that the packing can seal the magnetic passage against the atmosphere.

The present invention therefore seeks to provide an improved electronic control device which can be assembled more easily by reduction of the number of parts to be assembled as well as requires no enlargement of waterproofing part.

### SUMMARY OF THE INVENTION

According to an aspect of the present invention, an electronic control device includes plural cylindrical coils and a set of a primary yoke and a secondary yoke. The primary yoke is provided at each one side of the plural coils and the secondary yoke is provided at each the other side of the plural coils in axial direction. A case member houses the plural coils, the primary yoke, and the secondary yoke. The primary yoke is connected to the secondary yoke and has lateral portions extending in the axial direction of the plural coils.

According to another aspect of the present invention, the case member is made of a resin material, and the plural cylindrical coils, the primary yoke, and the secondary yoke are embedded in the case member by integral molding. A cross section of the primary yoke has an approximately reverse U-shape.

### BRIEF DESCRIPTION OF THE DRAWING FIGURES

The foregoing and additional features and characteristics of the present invention will become more apparent from the following detailed description considered with reference to the accompanying drawing figures wherein:

FIG. 1 is a cross sectional view of a main part of an electronic control device according to an embodiment of the present invention;

FIG. 2 is a cross sectional view taken along the line A-A of FIG. 1;

FIG. 3 is a cross sectional view taken along the line B-B of FIG. 1; and

FIG. 4 is a bottom view of the electronic control device before assembling to a pressure control device.

### DETAILED DESCRIPTION OF THE INVENTION

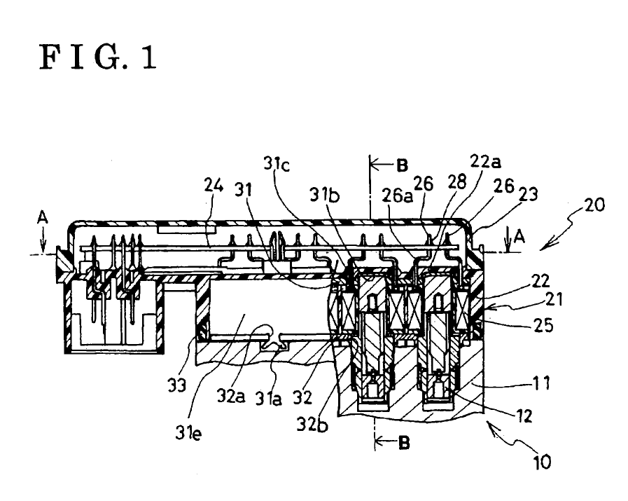

FIGS. 1-4 show an electronic control device according to an embodiment of the present invention. In the embodiment, an electronic control device 20 is assembled to a pressure control device 10 for controlling brake fluid pressure operating an ABS actuator of a vehicle. The pressure control device 10 and the electronic control device 20 are generally mounted within an engine compartment of the vehicle.

A motor driven hydraulic pump (not shown) and a hydraulic circuit (not shown) are provided within the pressure control device 10. A housing 11 of the pressure control device 10 is made of aluminum alloy, and each one part of eight solenoid valves 12 and 13 is accommodated in the housing 11. The solenoid valves 12 and 13 are, as shown in FIG. 3, composed of four pairs of 2 WAY-valves having two types of valves (normal-open valves 13 and normal-closed valves 12). All the solenoid valves 12 shown in FIG. 1 are the normal-closed valves. The electronic control device 20 has a board 24 where electronic parts (not shown) for controlling the solenoid valves 12 and 13 are provided and a case member 21. The case member 21 houses the board 24, eight cylindrical coils 25 corresponding to the solenoid valves 12 and 13, and a set of yokes (a primary yoke 31 and a secondary yoke 32). The primary yoke 31 is provided at each one side of the cylindrical coils 25 and the secondary yoke 32 is provided at each the other side of the cylindrical coils 25 in axial direction. The set of the primary yoke 31 and the secondary yoke 32 covers the entire cylindrical coils 25.

The case member 21 is composed of a case body 22 and a case cover 23 which are made of a resin material, and the case cover 23 is tightly connected to the case body 22 by welding. The case body 22 is fixed to the housing 11 via packing 33 by four bolts 34. This packing 33 is located within portions where the bolts 34 are located. Thus, an inner part of the case member 21 is sealed against the atmosphere.

An intermediate wall 22a and a holding part 22b are integrally formed on the case body 22. The intermediate wall 22a divides the board 24 from the coils 25. The holding part 22b has a function, what we call snap fit, so the board 24 can be easily assembled and tightly fixed without using other fixing means.

The coils 25 are formed by bobbins made of a resin material and wires coiled around the bobbins, and each end of the wires is connected to terminals 26. The terminals 26 extend upward (a direction in FIG. 1), and the coils 25 sides of the terminals 26 are partially covered by a resin material.

The primary yoke 31 is made of a magnetic material and has a reverse U-shape opening downward (a direction in FIG. 1). The primary yoke 31 has two lateral parts 31e facing each other and extending from an upper part of the primary yoke 31 in the axial direction of the coils 25. Recess parts 31b are formed on a bottom face of the primary yoke 31 and can face upper ends of the solenoid valves 12. Cylindrical parts 31d and holes 31c are also formed on the bottom face of the primary yoke 31. The cylindrical parts 31d can face upper ends of the solenoid valves 13 and perpendicular to the bottom face of the primary yoke 31. The terminals 26 are inserted through the holes 31c. Three fixing parts 31a having a pair of clamps are provided at each end of the lateral parts 31e of the primary yoke 31.

The secondary yoke 32 is also made of the magnetic material and has a plate shape. Cylindrical parts 32b perpendicular to the plate shaped body part are formed on the secondary yoke 32 and can face intermediate parts of the solenoid valves 12 and 13. Each end of the secondary yoke 32 has three groove parts 32a for receiving the foregoing three fixing parts 31a.

After the coils 25 are assembled to the primary yoke 31 and the secondary yoke 32, the fixing parts 31a formed on the primary yoke 31 are accommodated in the groove parts 32a, and then each pair of clamps is opened so that the primary yoke 31 can be tightly fixed to the secondary yoke 32. The set of yokes 31 and 32 to which the coils 25 have been assembled is embedded in the case body 22 by integral molding. The primary yoke 31 closely contacts with the intermediate wall 22a, and the terminals 26 project from the intermediate wall 22a.

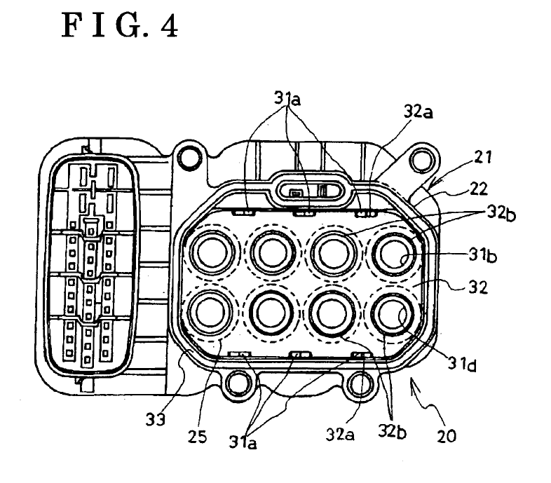

As shown in FIG. 4, the fixing parts 31a and the groove parts 32a are located in the middle of each cylindrical part 32b at each end of the secondary yoke 32.

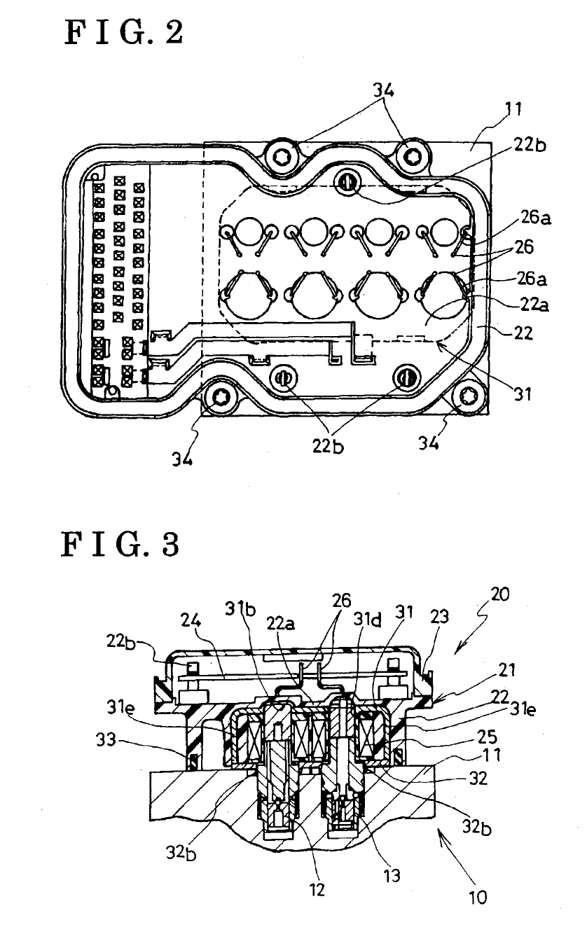

In the embodiment of the present invention, two terminals 26 per one coil 25, or total sixteen terminals 26 are provided (numerals are expediently indicated only for two terminals in FIG. 2), and each end of the terminals 26 is electrically connected to the board 24 by soldering. Each terminal 26 has a stress absorbing means 26a. Each stress absorbing means 26a has two L-shaped parts between the board 24 and the intermediate wall 22a, and each L-shaped part includes two bended parts with an angle of approximately 90°.

The electronic control device 20 is mounted in the engine compartment of the vehicle. Consequently, the device is affected by heat generated by the engine, and the case member 21 may be deformed and particularly, soldering parts on connection parts 28 between the terminals 26 and the board 24 may be broken by a difference in a coefficient of thermal expansion between a resin made board and metal terminals. Each stress absorbing means 26a can reduce stress generated on each connection part 28 by thermal load and prevent a solder break.

Operation of the above described electronic control device according to the present invention is not different from that of the known conventional electronic control device. Based on indication from a controller (not shown) for controlling the device, the coils 25 are energized by power supply via the terminals 26, and then the solenoid valves 12 and 13 are operated and controlled.

In the solenoid valves 12, when the coils 25 are energized, magnetic flux is generated. The magnetic flux circularly passes through the upper ends of the solenoid valves 12, the recess parts 31b of the primary yoke 31, the lateral parts 31e, the cylindrical parts 32b of the secondary yoke 32, the intermediate parts of the solenoid valves 12, and the upper ends of the solenoid valves 12 again. By the magnetic flux, suction force is generated in the normal-closed valves 12, and then the valves 12 are opened.

In the same way, magnetic flux is generated in the solenoid valves 13. The magnetic flux circularly passes through the upper ends of the solenoid valves 13, the cylindrical parts 31d of the primary yoke 31, the lateral parts 31e, the cylindrical parts 32b of the secondary yoke 32, the intermediate parts of the solenoid valves 13, and the upper ends of the solenoid valves 13 again. Thus, in the normal-open valves 13, suction force is generated as with the valves 12, and then the valves 13 are closed.

In the electronic control device according to the present invention, the set of the primary yoke 31 and secondary yoke 32 covers the entire coils 25, so the number of parts to be assembled can be reduced. Additionally, the primary yoke 31 is magnetically connected to the secondary yoke 32 via the lateral parts 31e included in the primary yoke 31 and extending from the upper part of the primary yoke 31 in the axial direction of the coils 25. Consequently, a steady magnetic field can be ensured, and magnetomotive force equivalent of that of the known electronic device can be achieved. Further, since the packing 33 for sealing the inner part of the case member 21 against the atmosphere is provided within portions where the bolt 34 are located, waterproofing part can be reduced, and then a structure with compact body can be formed as well as with high reliability.

Additionally, plural coils 25, the primary yoke 31, and the secondary yoke 32 are integrally embedded in the case body 22, complex operation can be reduced, and then assembly operation becomes easier. Further, a cross section of the primary yoke 31 has an approximately reverse U-shape, so the lateral parts 31e of the primary yoke 31, the recess parts 31b, and the cylindrical parts 31d can be integrally formed by easy and low-cost method such as press molding.

As described above, according to the present invention, an electronic control device, which can be assembled more easily by reduction of the number of parts to be assembled as well as requires no enlargement of waterproofing part sealed by packing against the atmosphere, can be attained.

The principles, preferred embodiments and mode of operation of the present invention have been described in the foregoing specification. However, the invention which is intended to be protected is not to be construed as limited to the particular embodiments disclosed. Further, the embodiments described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What we claim is:

1. An electronic control device, comprising:
plural cylindrical coils;
a set of a primary yoke and a secondary yoke, the primary yoke being provided at each one side of the plural coils and the secondary yoke being provided at each the other side of the plural coils in axial direction; and
a case member housing the plural coils, the primary yoke, and the secondary yoke, wherein the primary yoke is connected to the secondary yoke and has lateral portions extending in the axial direction of the plural coils.

2. An electronic control device, according to claim 1, wherein the case member is made of a resin material, and the plural cylindrical coils, the primary yoke, and the secondary yoke are embedded in the case member by integral molding.

3. An electronic control device, according to claim 1, wherein a cross section of the primary yoke has an approximately reverse U-shape.

4. An electronic control device, according to claim 1, wherein the primary yoke and the secondary yoke are made of a magnetic metallic plate.

5. An electronic control device, according to claim 4, wherein a fixing means for tightly fixing the primary yoke to the secondary yoke is provided at each end of the lateral portions of the primary yoke.

6. An electronic control device, according to claim 5, wherein the fixing means includes a pair of clamps.

7. An electronic control device, according to claim 1, wherein the primary yoke and the secondary yoke are made of a magnetic material.
